(19) United States
(12) Patent Application Publication
(10) Pub. No.: US 2009/0192871 A1
(43) Pub. Date: Jul. 30, 2009

(54) Business Social Network Advertising

(75) Inventors: David A.G. Deacon, Los Altos, CA (US); Rock Clapper, Palo Alto, CA (US); Jessica Verrilli, Seattle, WA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: LinksManager LLC, Alpharetta, GA (US)

(21) Appl. No.: 12/022,107

(22) Filed: Jan. 29, 2008

(51) Int. Cl. G06Q 30/00; G06Q 10/00

(52) U.S. Cl. 705/10; 705/14; 705/7

(57) ABSTRACT

Tools for enhancing participation in an web-based social network of businesses. For instance, such tools may encourage members of such networks to invite other members, providing viral growth of the network. As another example, the tools may encourage members of such networks to improve their web sites, which effectively will produce more traffic at such web sites. Because, in an aspect, some embodiments also include serving advertisements on web pages at members' web sites, increased traffic at such web sites results in additional “hits” on the served advertisements, producing additional revenue for the member and for the provider that maintains the business social network and/or serves the advertisements.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD OF THE INVENTION

The present invention relates, in general, to Internet-based social networks and, more particularly, to tools for encouraging participation in social networks of businesses and/or delivering advertising relevant to members of such networks.

### BACKGROUND

Small businesses face a daunting array of challenges with very limited resources. Businessmen responsible for the growth of small businesses, whether they be owners of the businesses or hired by the businesses, typically lack the time to educate themselves about best practices in their business area, thereby limiting the growth potential of the business. A growing number of such businesses have turned to the Internet to promote their businesses and increase revenues. While e-commerce holds the potential for rapid revenue growth, the requirements for managing this new type of business demand even more business learning. The opportunity is new but the conundrum is the same. While transactions on the internet are more scalable than transactions through a bricks-and-mortar storefront, new business challenges arise around unfamiliar activities such as bringing in additional web traffic and exploiting advertising revenue.

Many tools exist for meeting these challenges, including link management services to help grow traffic organically by creating more links from other web sites, and through search engine optimization. However, the providers of linking or advertising services are only loosely aligned with their customers: the small businesses—the providers' business model extracts revenue directly or indirectly from the business, but the providers care little about the size or growth of any particular customer. Instead, they compete for new customers, looking for the largest and the fastest growing in their segment. Small businesses get left behind.

There are many reasons for individuals such as business owners and web site managers to join affinity groups that bring together individuals with common interests and/or characteristics. Individual web site managers benefit from exchanging news, information on best practices, and discussing problems of common interest among similar individuals who may be geographically widely separated. Although the core interests are business related, the individuals who manage a business have significant needs that can be met by a business social network. If the benefits provided by the business social network are large enough, members may be motivated to recommend friends and associates to join the network. The resulting viral growth expands the number of participants in each area of interest, allows businesses to expand their list of contacts, and helps businesses grow their customer list through customers of non competing but related contacts. The value of the network to each participant grows with the number of participants, so membership growth encourages more membership growth. To the network, membership growth means more advertising revenue, so the network is strongly incented to provide the maximum benefits for its members.

The interests of the business social network and its customers are intimately aligned. Unfortunately, no social networks have developed a business model to appeal to small businesses. Existing social networks such as Facebook, Myspace, and Orkut focus on social exchanges and have little relevance to businesses. Even Linkedln and Plaxo, social networks designed to attract professional people, focus on each person's individual needs, not the needs of the businesses where the professionals may work. Since there are no social networks that serve small businesses, there are no proven business models in this area. However as we have seen there is a strong need for business models, organized along social networking principles, to provide services to small businesses.

Internet-based advertising is very ineffective for many small businesses today because of the dilatation of advertising messages when distributed by Internet. For a national or international) brand, Internet advertising can be cost-effective because most users of the Internet, irrespective of location, may be a potential customer. A large number of businesses (especially small businesses) are inherently local, however. Such businesses include, without limitation, real estate agencies, restaurants, nursing homes, hairdressers, and such. These businesses traditionally have not been well served by Internet-based advertising, which is inherently global. They may be interested in advertising only if their advertisements can be served to browsers with a local interest. However, search advertising does not work well in this context since searches that include local city names are diluted by many global results such as newspaper articles and blogs that discuss recent events, politics, disasters, or statistics that refer to a particular locality or business. Local organizations such as the Lions or the Rotary or the Chamber of Commerce that represent or support local businessmen do not usually provide internet advertising. Hence, there is a need for an advertising service that can serve ads to customers interested in a particular locality.

The cost of advertising is another significant barrier to its use by small businesses, even if a local delivery method were available. Internet advertising services live by the revenue share they obtain by serving the advertisements on the pages of the customer's web site. Promotions have been used to offer free advertisements on a trial basis to induce customers to use their service, or in exchange for revenue in other areas. Advertisement-serving businesses cannot be expected to offer free advertisements to their customers on an ongoing basis. Such an arrangement would undercut the basic business model of the advertising business. There is a need for a business model that will supply free advertising to small business, but it would be counterintuitive to build such a business based on advertising revenue.

The quality of web content on small business web sites is a problem due to the limited time and money available to the small business owner for improving the business web site. In addition, while there may be a large benefit to be captured by such activity, if the business owner is skeptical of, or merely unaware of, the potential return on investment in his web site, nothing will be done. Furthermore, if the business is inherently local, there may be no good way to attract customers over the web. The barriers add up fast for the small business (expense, time demands, bad experiences, not knowing how, can't reach the right customers) and it is easy to see why many businesses cannot exploit the possibilities offered by the web. While an advertisement-serving business would, in principle, benefit from each of its customers improving their web sites (and therefore presumably attracting more traffic), it has no tools or incentive to break down these barriers. Hence, there is an unmet need for a business model that can derive profit from the education and growth of individual business customers, introducing them to the real potential of promoting their businesses over the web and encouraging them to adopt best practices that have been shown to work by similar businesses. Clearly, the incentives in the business models of existing advertising businesses do not produce such a result. A new business model is needed.

### BRIEF SUMMARY

In an aspect, embodiments of the present invention provide tools for enhancing participation in a web-based social network of businesses. Merely by way of example, certain embodiments encourage members of such networks to invite other members, providing viral growth of the network. As another example, other embodiments encourage members of such networks to improve their web sites, which effectively will produce more traffic at such web sites. Because, in an aspect, some embodiments also include serving advertisements on web pages at members' web sites, increased traffic at such web sites results in additional “hits” on the served advertisements, producing additional revenue for the member and for the provider that maintains the business social network and/or serves the advertisements.

One way in which embodiments of the invention may encourage participation in social networks is by providing useful business services to members of a business social network, including advertising; in an aspect, the services are designed so as to be viewed as valuable by the members. In another aspect, encouragement of participation might comprise providing such services at no (or reduced) cost to members of the network and to support the operation of the network based on advertising revenues. Additionally and/or alternatively, embodiments of the invention can facilitate the sharing of best business practices so that traffic on separate member web sites (that are distinct from the pages on the network's web site) increases and both members and the network benefit from increased revenues.

Another way in which certain embodiments of the present invention encourage participation by members is through rewarding members for inviting others to join the network, increasing the value of the network for both members and the network, and/or through rewarding members for improving their web sites (which may be web pages on a web site associated with the social network and/or may be commercial websites, separate from the social network's web site, that pertain to businesses associated with members of the social network).

In a particular embodiment, such rewards may comprise providing free (or reduced-cost) advertising to members who invite new members, improve their web pages, and/or the like. Such advertising may be placed on web pages within the social network (i.e., web pages on a server associated with the social network) and/or on separate websites (which may be, but need not be, associated with members of the social network). In a beneficial aspect, the member receiving the reward may be given the opportunity to select the location for such advertisements (e.g., web pages on which such advertisements are to be displayed). Merely by way of example, the member might be given the opportunity to select web pages associated with businesses that are in relatively close physical proximity (e.g., the same metropolitan area, the same zip code and/or area code, etc.) as a business associated with the member, web pages that are associated with businesses offering products complementary to those of the member's business, and/or the like.

The tools provided by various embodiments of the invention include, without limitation, methods, systems, and/or software products. Mainly by way of example, a method might comprise one or more procedures, any or all of which are executed by a computer system. Correspondingly, an embodiment might comprise a computer system configured with instructions to perform one or more procedures in accordance with methods of the invention. Similarly, a computer program might comprise a set of instructions that are executable by a computer system (and/or a processor therein) to perform such operations. In many cases, such software programs are encoded on physical and/or tangible computer readable media (such as, merely by way of example, optical media, magnetic media, and/or the like).

Merely by way of example, one set of embodiments provides methods, including without limitation methods of enhancing participation in a web based network, such as a web-based business social network. One exemplary method comprises maintaining a web-based social network of businesses; in an aspect, the social network comprises a plurality of relationships among a plurality of members, including a first member that is associated with a first business having a first physical location. In another aspect, the web-based social network further comprises (and/or is defined by) a network web site, which might comprise a network web page associated with the first member. In some cases, the first member further has associated therewith a commercial web site separate from the network web site.

The exemplary method, in some embodiments, further comprises placing paid advertisements on one or more web pages and/or charging a fee for the placement of each paid advertisement. In a particular set of embodiments, the method also includes providing an interface to allow each member to invite additional businesses to join the web-based social network and/or allocating, to the first member, a first allocation of one or more advertisements for the first business, e.g., based on a determination that the first member has invited an additional business to joint the web-based social network.

In other embodiments, the exemplary method includes periodically crawling, e.g., with a spider component, the commercial web site to identify content on the commercial web site. The quality of content of the commercial web site may be analyzed, and/or based on an analysis of the quality of the content of the commercial web site, the method may include calculating an advertising value of the commercial web site. Accordingly, the method might further include allocating, to the first member, a second allocation of one or more advertisements for the first business, based on the calculated advertising value of the commercial web site. In an aspect, allocating, to the first member, the first and second allocations of one more advertisements for the first business comprises placing the one or more allocated advertisements on one or more web pages without charging the first member a fee for placement of the one or more advertisements.

Another set of embodiments provides software programs, including without limitation software programs that implement (e.g., can be used to program a computer system to perform) methods of the invention, and/or various procedures thereof. Merely by way of example, one embodiment provides an apparatus that comprises a computer readable medium having encoded thereon a set of instructions executable by a computer system to perform one or more operations.

In an aspect, the set of instructions comprises instructions for maintaining a web-based social network of businesses; the social network might comprise a plurality of relationships among a plurality of members, including a first member that is associated with a first business having a first physical location. In another aspect, the web-based social network might further comprise (and/or be defined by) a network web site, which might comprise a network web page associated with the first member. In a further aspect, the first member might also be associated with a commercial web site separate from the network web site.

The set of instructions might further comprise instructions for periodically crawling, e.g., with a spider component, the commercial web site to identify content on the commercial web site. There might also be instructions for analyzing a quality of content of the commercial web site and/or for instructions for calculating an advertising value of the commercial web site, based on an analysis of the quality of the content of the commercial web site. In some embodiments, the set of instructions also includes instructions for allocating, to the first member, an allocation one or more advertisements for the first business, based at least in part on the calculated advertising value of the commercial web site.

A further set of embodiments provides systems, including without limitation computer systems that implement methods of the invention and/or execute software programs of the invention. An exemplary system for enhancing participation in a web-based business network comprises a processor and a computer readable medium in communication with the processor. In an aspect, the computer readable medium has encoded thereon a set of instructions executable by the computer system to perform one or more operations.

Merely by way of example, the set of instructions might comprise instructions for maintaining a web-based social network of businesses, the social network comprising a plurality of relationships among a plurality of members, including a first member that is associated with a first business having a first physical location. In an aspect, the web-based social network might further comprise (and/or be defined by) a network web site; in another aspect, the network web site might comprises a network web page associated with the first member.

In some embodiments, the set of instructions further comprises instructions for providing an interface to allow each member to invite additional businesses to join the web-based social network, instructions for determining that the first member has invited a non-member to join the web-based social network, and/or instructions for allocating, to the first member, an allocation of one or more advertisements for the first business, based on a determination that the first member has invited a non-member to join the web-based social network.

An exemplary computer system in accordance with another set of embodiments comprises a processor and a computer readable medium in communication with the processor. In an aspect, the computer readable medium has encoded thereon a set of instructions executable by the computer system to provide an advertising network web site for members of an affinity network. In an aspect, the advertising network web site comprises at least an advertising network web page for providing members an advertising service to serve network advertising on web pages on a web site associated with a member of the affinity network.

In particular embodiments, the advertising service comprises a spidering service configured to determine member web page content data, which comprises information about one or more locations of network advertisements within each member web page. The advertising service might further comprise an advertising value calculation engine for calculating an advertising value of a member web page based on one or more factors (which might include, merely by way of example, a number of network advertisements on the member web page, one or more locations of network advertisements on the member web page, and/or a quality of content on the member web page).

In other embodiments, the advertising service might further comprise a network advertising server that serves advertisements to member web pages based on relevance of each advertisement to member web page content data. In an aspect, the network advertisements might comprise paid advertisements sourced from commercial advertisers and/or and member advertisements sourced from one or more members of the affinity network to promote businesses associated with the one or more members of the affinity network. In some cases, an earned number of member advertisements that are served by the network advertising server on behalf of a member depends on the advertising value of the member web pages, as calculated by the advertising value calculation engine.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral to denote one of multiple similar components. When reference is made to a reference numeral without specification to an existing sublabel, it is intended to refer to all such multiple similar components.

FIG. 1 illustrates an affinity network web site, in accordance with various embodiments of the present invention;

FIG. 2 illustrates functional components of an advertising network web site, in accordance with various embodiments of the present invention;

FIG. 3 illustrates functional components network advertising service, in accordance with various embodiments of the present invention;

FIG. 4 is a generalized block diagram illustrating a system for providing a social business network advertising solution, in accordance with various embodiments of the present invention;

FIG. 5 is a process flow diagram illustrating a method of providing advertising on web sites, in accordance with various embodiments of the present invention;

FIGS. 6 and 7 are process flow diagrams illustrating methods of rewarding members of a social business network, in accordance with various embodiments of the present invention;

FIG. 8 is a generalized schematic diagram illustrating a computer system, in accordance with various embodiments of the invention; and

FIG. 9 is a block diagram illustrating a networked system of computers, which can be used in accordance with various embodiments of the invention.

### DETAILED DESCRIPTION OF THE INVENTION

While various aspects of embodiments of the invention have been summarized above, the following detailed description illustrates exemplary embodiments in further detail to enable one of skill in the art to practice the invention. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form. Several embodiments of the invention are described below, and while various features are ascribed to different embodiments, it should be appreciated that the features described with respect to one embodiment may be incorporated with another embodiments as well. By the same token, however, no single feature or features of any described embodiment should be considered essential to the invention, as other embodiments of the invention may omit such features.

One set of embodiments comprises tools (e.g., methods, systems, software, etc.) for providing a business network (e.g., via a web site that provides a framework for the network, web pages for members of the network, etc.) and/or for providing advertising relevant to members of a business network. As used herein, the terms “business network” and “business social network” means a type of affinity network in which the members share an interest in the success of business operations (and, in a particular aspect, small business operations); in an embodiment, a business network has significant social networking aspects and may be called a business social network.

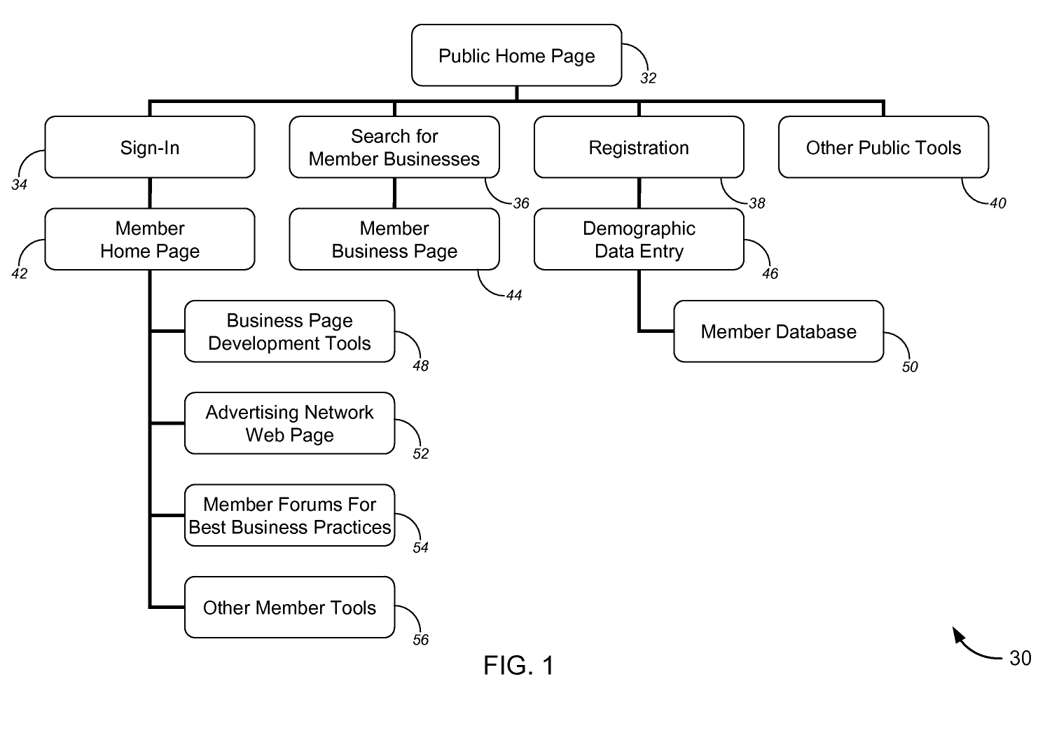

FIG. 1 illustrates an affinity network web site 30 (which might be used to provide a business social network) comprising a public home page 32 offering, in the illustrated embodiment, at least three services to the public: a search page 36 for finding businesses that are members of the network, a sign-in page 34 for members to access members-only features, and a registration page 38 to allow non members to sign up to become new members of the network. As used herein, the term “web page”(or, for simplicity, “page”) refers to any set of content that is displayable in a web browser and/or served by a web server; in an aspect, a web page may include HTML code; images, videos and/or other media; references (e.g., hyperlinks, anchors, etc.) to other pages, and/or the like. In some cases, a page may be a subset of another page, may include other pages and/or refer to other pages, or it may stand alone.

In some cases, the network web site 30 includes a database of members 50, which comprises information about each of the members of the business social network. Such information can include biographical information, demographic information (such the name and/or nature of the member's business, the location of the business, other interests and/or characteristics of the member, etc.), and/or the like. The database is maintained by the business social network (and/or, more precisely, by the provider of the business social network, adding information about existing members from time to time such as web browsing behavior, product interests, purchasing history, and so on. The database also includes information on the commercial web site associated with the member, if any, including information such as the page content, the content history, and traffic data. New members are requested to enter information to specify demographic information, and update requests are generated from time to time to provide missing information. To secure the database, multiple copies are maintained at several locations in case of power failure or local disaster. To enable rapid processing of information from the database, it is preferably segmented and managed by multiple servers.

The network web site, in an embodiment, might also include a search page 36, which provides an interface to a search function (which might be provided by any of a variety of commercially-available search engine) that searches the member database 50 and/or contents of the member business pages 44 and/or the contents of one or more commercial web sites separate from the business social network but associated with members of the network. This search function, in an aspect, returns a member business page 44 or a group of member business pages for the searcher to browse, based on criteria supplied by the user via the interface on the search page 36. In one aspect, the member business pages 44 (also referred to herein as “member pages” are part of the network web site 30 (e.g., stored on a web server associated with the network web site 30, formatted with a style common to the network web site 30, and/or the like). In another aspect, a member page 44 might comprise a link to a commercial web site (which may be separate from the network web site 30) associated with the member's business, such that further browsing takes the browser directly to the member's commercial web site. Any of a variety of searches can be supported, including without limitation searches on business name, product name, product category, business location, and/or other factors useful to members of the network.

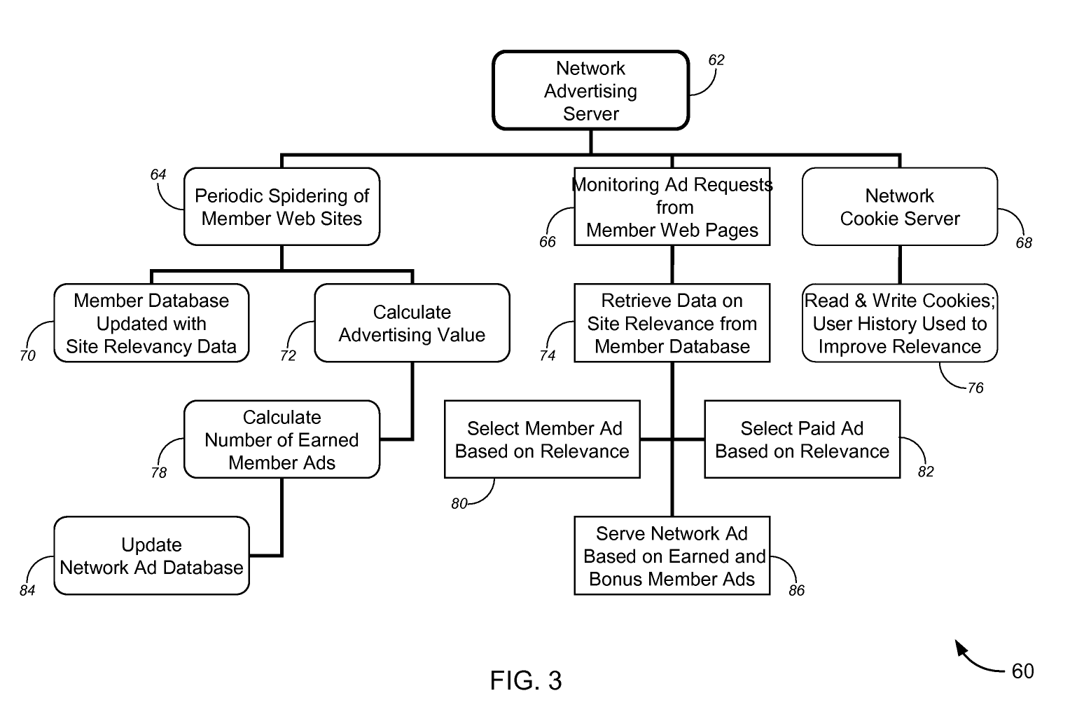

If a single member business is the result of the search, that member's business page may be displayed for the user. If the search results include multiple member businesses, the search interface might provide a list of the results, perhaps with each member page displayed as a text link, an iconified (e.g., reduced size and/or resolution) version of the respective member page, an iconified version of the main graphic on the member page, and/or the like. The search results may be filtered and/or sorted by multiple factors that describe the intent of the searcher, including relevance to the search phrase entered by the searcher and browsing history information obtained from the advertising database with the aid of a user cookie. Advertisements provided by the network (and/or a provider thereof) (which are referred to herein as “network advertisements”) will be served by the network advertising server 62 (e.g., as described below with respect to FIG. 3) across the network, i.e. to the network web site pages such as pages 32-40, and/or to commercial web sites separate from the network web site.

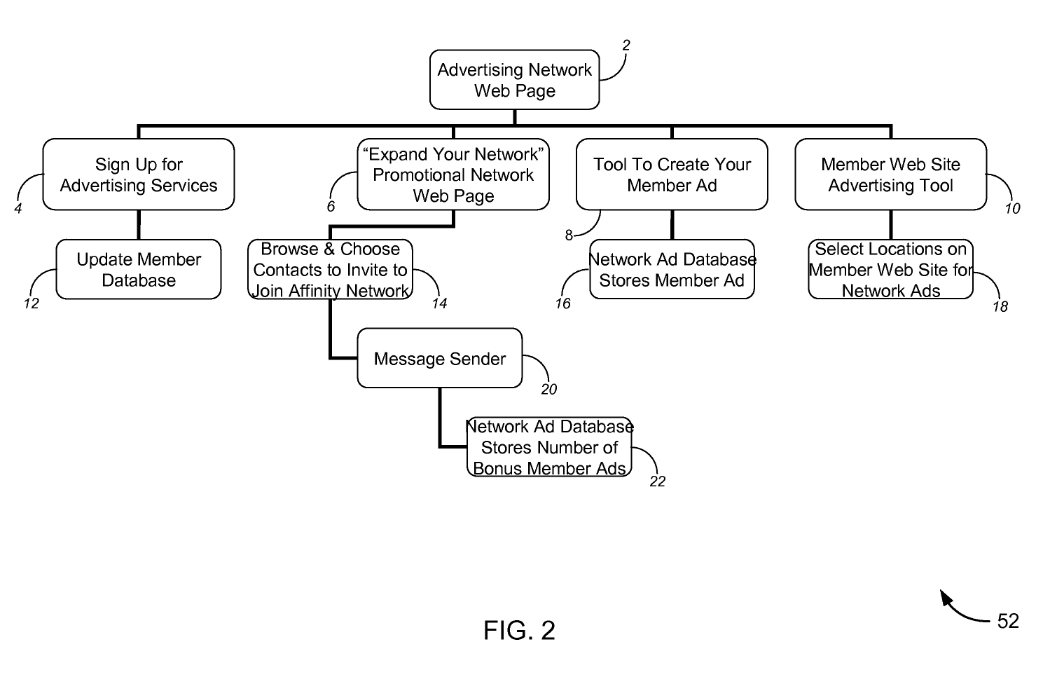

The sign-in page 34 authenticates the identity of a member wishing to access the network web site 30. Upon authentication, the member may be provided with access to his or her home page 42. Member home pages 42 are preferably personalized to emphasize the information that is most relevant to the member's own interests. The member's home page 42 is accessible directly only by a member, and is a different page than the member's business page 44, which provides information about the member's business, for use by other members A member may also have a network page on the network web site that is a personal page containing information about the member and accessible to other members. A member who is an employee of a business, for example, may wish to provide a personal page describing himself as distinct from the business, including such information as a photograph, professional background, personal interests, personal contacts, and so on. According to a member's interests, he may also provide personal information on his business page. In an aspect, member home page 42 include tools pages 56 that provide functions such as finding potential contacts, adding contacts, linking to contacts, inviting contacts to join the network, and access to member contacts in a form that is preferably sortable by category (supplier, customer, local business, business type, and so on). In another aspect, members are rewarded for inviting contacts to join the network e.g. through the “Expand your Network” page 6 that is also one of the tools pages 56. In some embodiments, the reward for inviting contacts to membership may be the allocation of a quantity of bonus member advertisements for advertising the member's business; such bonus advertisements may be allocated (e.g., recorded in a network advertising database 22, illustrated on FIG. 2) upon the invited member joining the network, as described in further detail below. In some cases, these member advertisements are served by the network advertising server 62 according to the wishes of the member; hence, the member may be given the option of selecting locations (e.g., web pages) on which the bonus advertisements are to be displayed. The web pages on which bonus advertising is to be displayed may be selected based, for example, on demographic information such as the physical location of the business associated with the web page, products provided by such businesses, reputations of such businesses, quality of the web page, traffic statistics for the web page, and/or the like.

For many small businesses that do business locally, the most important piece of demographic information is the locality of another member's business. It is important to note that ads can be served to browsers with a local interest by serving those ads only on web pages of member businesses located in the desired advertising location. Smart linking practices allow web sites of businesses with a physical presence in a certain town or zip code to exchange reciprocal links with other local members to share local traffic with each other. Using the affinity network to advertise now allows these businesses to advertise locally by targeting the web sites of other local businesses.

In some embodiments, an additional reward is provided for inviting contacts to joining the network, namely, the step of serving the newly registered member a quantity of member advertisements from the member who invited the new member. This additional reward step reminds the new member that members get no-cost advertising rewards thereby encouraging him to sign up for advertising, and provides some extra prestige for the recommending member when the new member notices the advertisement of the member who invited him.

The network web site 30 also includes a registration page 38 for nonmembers to sign up as new members and provide demographic information on themselves and/or their businesses (e.g., through a demographic data entry interface 46, which, for example, might provide an HTML form, Java applet, etc. that prompts the new member to provide requested data and/or provides input fields to provide such data). This information is stored in the member database 50. In an aspect, by cross checking the registration information for a new user against a list of invited contact, the system can determine whether the new member was invited by a member. (Alternatively, the new member may be prompted to provide the identify of an inviting member, if any). Based on this information, the system may calculate an allocation of additional member advertisements, as described elsewhere herein, which are added to the network advertising database 22.

The network web site 30 may also include other public tools 40 to attract the public to the network web site 30. Merely by way of example, a member search function might allow contact to be made with a member of the network privately through the network without revealing the member's contact information until the member chooses to do so.

The mechanics of this search function may be similar to those described with respect to the search function described above with respect to the search page 36, although the level of information provided by the returned results might vary according to whether the search is performed by a member or a non-member. (In some cases, a non-member may be prompted to join the business social network in order to see other information.) Merely by way of example, when using the search tool, members may be provided with a member ranking of other members (e.g., those returned as part of the search results) to enhance their interactions, as described in further detail below.

Public tools 40 may also include additional attractive features, such as articles and/or other content (which may be supplied by members) about topics of interest, either to the general public or to specific segments of the public, such as potential purchasers of a particular type of product, etc. Such tools can include buyer's guides, how-to advice, and/or the like.

The network web site 30 might also provide one or more tools 48 to help members create an attractive member business page 44. These tools 48, for example, may be configured to provide suggestions on creating an attractive layout with a good balance between text and graphics, enables easy uploading of graphics and photographs, and creates the desired links to pages of a member's own web site. Such tools can include, without limitation, any number of proprietary and/or commercially-available style guides, web-page authoring software, and/or the like.

FIG. 1 further illustrates an example of some elements that might be provided on a member home page 24. Merely by way of example, member forum pages 54 may be provided to enable discussion among members and exchange of information such as best business practices among groups of members with the same interests. In an aspect, any of a variety of available forum-management tools and/or bulletin-board management tools may be used to provide this functionality. Members may create forum groups and/or topics according to their own interests, and the creating members may provide cross references to other groups/topics. Some member activity such as the creation of new groups and/or topics will be subject to supervision by a moderator assigned the responsibility by the provider of the social network. In this manner, an unlimited number of overlapping groups and/or forums may be formed such as a welders' forum, a barbers' forum, a forum for Italian restaurants, a forum for sole proprietors, an employers' forum, a construction forum, and so on. Members may post questions, answers to questions, comments, links to articles, and other information of interest to the particular forum. The member who initiates a new forum may be assigned the responsibility of moderating the forum, including selection of topics/threads to be archived for permanent (or semi-permanent) storage, policing of content for inappropriate material (if desired), delegating moderator authority to other members, and/or the like. A search tool may be provided to help members locate information across the different forums.

One of the member tools pages 56 is a personalization page that enables members to choose between available content that may be displayed on the member home page 42, such as news feeds customized to the member's business interests, presence awareness tools to indicate the presence of other specified members on the network web site at any given time, a performance dashboard showing results of measurements of the member's web page traffic, and/or the like. Selected third party software (such as web authoring and/or administration software, various business tools, and/or the like) may be made available for use and/or purchase through one of the tools pages 56.

Another feature available on the member tools page 56 is a member ranking feature. Member rankings may include information regarding the number of contacts and/or connection a member has, the extent of a ranked member's participation in the forums, the number of new members that have been invited by the member, and/or comments (including, without limitation recommendations or complaints about the ranked member) provided by other members. A member ranking tool page in tools pages 56 enables members to commend other members, or even to initiate a complaint against a member, which can be resolved through a resolution process. The availability of member rankings to other members lends a degree of prestige to members who are particularly helpful and ethical.

Another feature that can be provided to a member from the member tools page 56 is a network badge the user may copy to his commercial web site. The badge is a graphic icon that identifies the business operating the commercial web site as a member of the network. A user visiting the commercial web site of a specific member may visit the member business page of that specific member by clicking on the badge which acts as a link to the member's business page. The badge may include the name of the network and announce that the commercial web site with the badge is a member of the network. Since a member's business page presents certain summary aspects of a business's reputation, members may wish to make their customers aware of their high reputation in the network. In some cases, a member may wish to use a personal network badge that links to the member's personal page on the network web site to make visitors aware of their personal member's reputation. The presence of the badge may also remind users that the member is committed to maintaining his favorable reputation, with the business social network acting as an impartial third party in keeping track of unresolved disputes.

In some embodiments, the member home page 42 also comprises a link to a set of advertising network web pages 52. Members who wish to benefit from the advertising service 60 provided by embodiments of the invention (as described in further detail below) may use a collection of advertising network web pages 52 to configure this service for their use. An important reason a member may be interested in the business social network is to enhance the member's business. Businesses that operate their own commercial web sites independent of the business social network may be interested in deriving additional revenue from their site through carrying advertising, distributing advertising to bring more traffic to their site, and other traffic enhancement tools such as links management. Functions provided by the business social network through the home page 42 (and, mores specifically, the advertising network pages 52) therefore include managing the network service that provides advertising to the member's commercial web site, managing the free advertising served on behalf of the member, creating the member advertising copy, and inviting new contacts (who might run valuable advertisements on their commercial web sites) to join the network. Commercial web sites may include sites connected to business that sell products or services, and they may also include publishers and many other types of organizations.

An example of a collection 52 of advertising network web pages, in accordance with one set of embodiments, is shown in FIG. 2. A top-level advertising network web page 2 is the major access point for members to manage their network advertising services. In an aspect, the top-level advertising network web page 2, that incorporates and/or provides links to other web pages in the collection. These other web pages can include a sign up web page 4 to allow a member to sign up for advertising services provided by the network, a invitation page 6 for inviting new members to join the network, a tools page 8 for creating and enhancing member advertisements, and/or a member web site advertising tool 10 for managing advertising on member web sites.

The sign up web page 4 allows members to sign up for advertising to be served by the affinity network to their web site. At this page 4 members must specify where they wish to be paid their advertising revenue, provide site data so that the spidering service 64 can find the site, and fill out any missing demographic data on the user. Member permission status, site data, and demographic data is updated 12 to the member database 50.

The promotional network web page 6 encourages members to expand their network of contacts by inviting them to join the affinity network. As noted above, in some aspects, the social network provided by embodiments of the invention can include a member ranking feature. In some cases, a member's ranking depends in part on the number of contacts the member is connected to. The member's ranking is displayed on this page, providing additional motivation to increase the member ranking. The number of local connections (i.e., the number of members in the same geographic area as the selected member, with whom the selected member has connections) is also displayed on this page, perhaps as a graphic showing their locations on a map centered on the member's business address. By selecting the number of direct connections or once removed connections, the member can appreciate the value of additional local connections. Local businesses who are not members of the network are preferably suggested to the member in page 6, either derived from the member's outlook contact file, from public databases, and/or the like. This page 6 also preferably contains linking tools enabling reciprocal links to be requested for the member web site with local business contacts.

On contact browsing page 14, the member is given the opportunity to browse among various contacts and/or select the contacts the member wishes to invite to join the network; in an aspect, the contract browsing page 14 also provides the member with the ability to specify a personalized message to be sent to for each contact. These messages of invitation and a link to the registration page 38 are sent by the message sender 20 (which might be, for example, an SMTP server configured with software configured to send appropriate email messages on behalf of the member) and/or data about the invitations (such as when the invitations were sent, to whom the invitations were sent, and/or the like) is stored in the member database 50. As described in further detail below, upon sending invitations (and/or upon the registration of a new member based on a sent invitations), an allocation of bonus member ads may be allocated to the inviting member.

A tool 8 for creating a member advertisement may be provided to help members develop attractive member ads to promote the members' businesses. The member ads are stored, as indicated in block 16, in a data store, such as a network ad database, and thereafter may be served by a network ad server (described below). Member ads may be bonus ads awarded based on specified conditions (for example, as described herein), or they may be paid advertisements, similar to those placed by non-members.

A member web site advertising tool 10 may be used by a member to manage the advertising service, including specifying which advertisers or types of advertisements are not to be served on his site. The member may also be provided with a location specification page 18, which helps a member specify which pages of the member's commercial web site should include ads, the size of the ads, and the location on each page. (Such information, of course, could also be specified by modification—either automatically by the tool or manually by the member or another—of the pages on the member's web site to include link references and/or anchors for advertisements.) This information may be stored in the network advertising database and/or may be updated by the member at any time.

FIG. 3 illustrates, functionally, an advertising service 60 which may be provided by a provider of a social network, in accordance with one set of embodiments. The service 60 may comprise and/or be implemented on a network advertising server 62, which may be (but need not be) incorporated within a web server that provides a social network as described above and/or configured to operate in conjunction with such a web server. In an aspect, the network advertising server 62 provides several services (which may be implemented as software applications, server processes, etc.) to facilitate the serving of advertisements across a social network.

Merely by way of example, in some embodiments the network advertising server 62 might comprise a spidering service 64 (also referred to as a “spider” or a “crawler” component or function). The spidering service 64 is a tool (such as a software application, etc.) that is configured to periodically visit members web pages' (either within the network—e.g., on a network web site—or outside the network, e.g., on a member's commercial web site) and/or downloads such pages. The spidering service 64 (and/or another component of the system 60) then may be configured to determine whether any of the web pages have changed (e.g., by comparing a visited web page with a previous version of the same web page) and/or update the network databases to note any changes to members' web sites.

The spidering service 64 periodically reads the information on one or more web pages (e.g., a member page on the network web site and/or some or all pages on a members' web site separate from the network web site), evaluates the content therein, and/or resolves any link references (e.g., hyperlinks) as necessary to determine the information available to a user visiting the member site. This information may be analyzed to determine both the quality of the content on the web pages (in an absolute sense) and/or any change (e.g., improvement) in the content since a prior visit. This analysis (and/or the information itself) then may be stored in a database (e.g., the member database), as indicated by block 70. In some embodiments, as described further below, an advertising value calculation engine applies an advertising value algorithm to calculate, as represented by block 72, an advertising value for the member's web site and/or pages. In an aspect, the advertising value is a numeric ranking that quantifies the quality of the web site/pages and can be used in an incentive program, as represented by block 72 and described in further detail below, to calculate a number of earned member advertisements (which generally is proportional—and/or otherwise related to—the advertising value of the member's site/pages. This number of earned member advertisements is allocated to the member, (e.g., by adding this data to a network advertising database 84, which is used by the network advertising server 62 to serve member ads, as represented by block 86 and described in further detail below.

In another aspect, the advertising service 60 may also include a monitoring service 66 to manage requests from monitored web pages (which can include both the member's web page in the network, as well as pages on the member's commercial web site) for advertisements to be served. Merely by way of example, in an embodiment, each monitored web page might comprise an advertisement served by the advertising server 62, or a least a pixel served by the server 62. This can be implemented, for example, as a hyperlink reference to the advertising server 62, such that when a user loads a monitored web page, the user's browser also requests, from the network advertising server 62, an advertisement (or the at least one pixel) from the advertising server 62, which is then displayed, in the user's browser, as part of the monitored web page . In an aspect, the format of the link reference may provide information to the network advertising server 62 (and/or, more precisely, the monitoring service 66) about the web page and/or web site the browser is accessing (e.g., by including in the URL of the request an identifying string that identifies the web page/site). In this way, traffic information for every monitored web page can be tracked by collecting information about the number of requests received from browsers visiting each respective monitored page/site.

In many implementations, it may also be beneficial to track each user (or, more precisely, each browser) that visits a monitored web page/web site. Hence, in some embodiments, the advertising service 60 further includes a network cookie service (which may be provided by a network cookie server 68, which in turn may be incorporated within the network advertising server 62 and/or implemented separately). The network cookie services manages cookies and associated data stored in a database, such as the network advertising database 84. Merely by way of example, in accordance with one embodiment, in response to an ad request (as described above), the network server 62 passes the browser's IP address to the network cookie server 68 which reads the cookie (if any) stored on the user's computer, and obtains the associated user browser history information stored in the advertising database 84. (Alternatively, the network advertising server 62 might perform this task itself.) Similarly, the network cookie server 68 (and/or the advertising server 62) may record, in the database 84, information about the browser's current request (e.g., an identification of the browser, an identification of the monitored page(s) visited during the session, and/or the like). In an aspect, the network cookie server 68 will also periodically refresh the cookie with an updated expiration date.

Beneficially, in some embodiments, the network advertising server 62 is configured to serve advertisements that are highly relevant to the user. This provides a benefit both to the user (who is not forced to view an advertisement for something that does not interest the user) and the advertiser (who gets a pair of relatively interested eyeballs, instead of a random viewer). Merely by way of example, in one embodiment, the server 62 retrieves relevancy data, represented by block 74, on the monitored web page being accessed, and combines this with user/browser history data (which may be collected as indicated above) to obtain an estimate of the user intent and/or user interest in a variety of different advertisements. For instance, in one set of embodiments, the nature of the web site being visited (and/or the network member associated with that web site) may be evaluated, based perhaps on information in the member database and/or information obtained by spidering the member's web pages/site. Merely by way of example, the physical location of the member's business, the types of products sold by the member's business, and/or specific content on the visited web page might be used as a factors in determining user interest. Similarly, these types of data can be compared (and/or evaluated in conjunction with) similar data from other monitored web sites previously visited by the browser, in order to determine the user's intent and/or level of interest in various topics.

Based on the user's intent/interest, the network advertising server might select an appropriate advertisement to serve to the user's browser. Hence, in some cases a member advertisement 80 (which may be a bonus advertisement allocated to a particular member as mentioned above and described in further detail below) may be selected from the network ad database, according to the estimate of user intent This ad is served, as represented by block 86, to the user's browser, and the number of allocated ads remaining for that member is reduced appropriately. Alternatively, a paid advertisement 82 is selected from a paid advertisement provider based on the estimate of user intent, this advertisement, which may have no relation to the network other than that it is served by the network, is served to the user, and the member web site is credited with a unit of advertising revenue in step 86. (In addition, in many cases, the network advertising server 62 tracks the number of paid advertisements served and bills each paying advertiser accordingly.) In an aspect, the network advertising server 62 intersperses the paid ads and the allocated member ads that are served, to achieve a balance in which the number of advertisements served on behalf of a given member is distributed reasonably uniformly in time, as is the advertising revenue earned by that member.

In one set of embodiments, the usage information resulting from the web page access is stored in the member database and used to calculate useful statistics on member traffic such as the number of visitors by web page, time of day, demographic information, unique visitors, repeat visitors, etc. In an embodiment of the present invention, these statistics are made available through a members' performance dashboard to members who use the network advertising service. In another embodiment of the invention the user traffic statistics are compared with those of similar member sites, and comparative data is provided to the user. This comparative data, in one aspect, is communicated to the member only twice or three times per year or so, allowing the member time to improve his web site. In another aspect, some or all of the usage data (including comparative data) may be provided to a member at any time, upon request by that member. The comparative data communication may also include a set of recommended corrective actions based on the areas where the member falls short. These recommendations, in an embodiment, are automatically generated based on the type of member business, the area of the shortfall, the size of any deficit compared to the statistics of comparative members, and the tools available within the network to address the deficit.

As noted above, in some embodiments, the advertising value of a member's web site/pages can be used for various purposes, including without limitation determining how many bonus advertisements should be allocated to that member. Hence, in an aspect of some embodiments, the advertising value algorithm used to calculate this value is a key element in the process of rewarding members for creating a quality web site that promotes the member's business. In one embodiment, as noted above, prior to calculating the advertising value, a member's web site is crawled by the spidering service to update the member database with the latest information about the member web site. In an aspect, with respect to a member's commercial web site, the advertising value of the web site is a numeric ranking that is calculated for the entire site and for every page of the web site by the advertising value algorithm. In an aspect, the advertising value of a site is derived from the collective advertising value of each of the site's pages. The advertising value of each page may be derived from several factors, including without limitation, the quality of content on the page, the number of unique visitors to the page in a given period of time, and/or the like. The advertising value algorithm assigns more advertising value to web pages that include original content sourced from the member web site and less value to pages including a large quantity of linked content. Moreover, the more links required to access the linked content the less value is assigned to the linked content. The inclusion quality content (including, for example, informative articles, graphics and/or video) add to the interest and attractiveness of web pages, so the algorithm assigns additional advertising value to pages with graphical and multimedia content. In some cases, the system may employ a rating system, by which visitors to a member web page can provide feedback on how interesting/useful they find the page; this data can also be used in calculating the advertising value of the page. Certain content types may also provide higher advertising value because of their rarity, utility to other users, and/or direct relevance to advertiser revenues.

In some embodiments, the advertising value of a page may also include, as a factor, how the page utilizes advertising. In an aspect of such embodiments, each ad provided on a page is assigned its own advertising value; these rankings are then combined by the algorithm with other factors (such as those described above) to derive/calculate the advertising value of the page. Merely by way of example, advertisements that are prominently placed on the upper right or upper left of the content might be ranked higher than ads placed at the bottom of a page. To a degree, larger ads may be ranked higher than smaller ads, but only so long as a balance is maintained between advertising and content that is pleasing to the viewer. Pages with too little content or that are dominated by advertising space are ranked lower by the algorithm, because visitors will tend to disregard such pages quickly. The inclusion of too many ads on a page, so that the advertisements continue beyond the content also lowers the advertising value of the page.

The number of bonus advertisements that are earned by each participating member is proportional to the total advertising value of the member's web site (and/or the member's network page), as calculated by the algorithm. The advertising value algorithm may be updated from time to time to reflect changes in web site and advertising practice, with the intent of corresponding the advertising value of a web page closely with the satisfaction of the user of that web page.

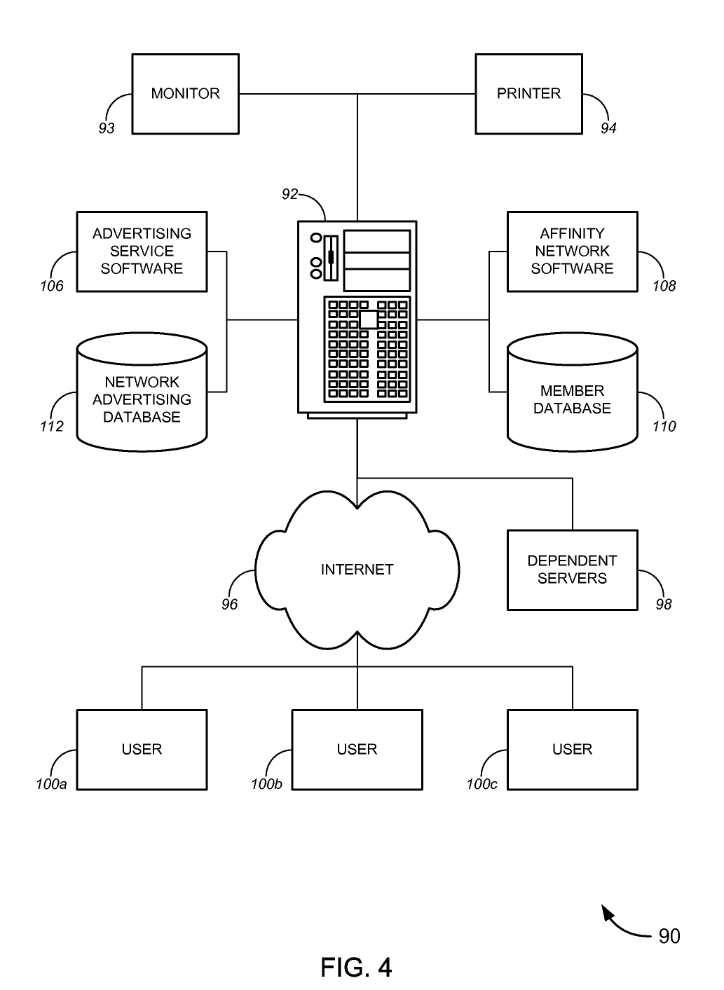

FIG. 4 shows a network system 90 in accordance with one embodiment of the present invention. The affinity network web site 30 and the advertising service 60 are provided via the system 90. The network system 90 comprises a server 92, which may be coupled to I/O devices such as a monitor 93 and a printer 94. The server 92 may also incorporate, and/or may be in communication with, a plurality of dependent servers 98 (which can include, without limitation, any of the servers described above, such as a cookie server, a network advertising server, a web server, and/or the like). In an embodiment, both the server and the dependent servers are in communication with the Internet 96, though any of a variety of known techniques. (Merely by way of example, each of the servers 92, 98 may be part of a local area network, which also comprises a gateway providing access to the Internet 96.) In particular, the Internet 96 (or any other appropriate network) provides communication between the servers 92, 98 and a plurality of users 100 (or, more specifically, with computers operated by the users). A user 100 may be, but need not be, a member of a social network implemented by the server 92. The servers 92, 98 collectively are programmed with software for implementing methods of the invention, such as affinity network software 108 and advertising service software 106. The servers 92, 98 also may comprise, and/or be in communication with, one or more data stores, including without limitation a member database 110 and/or a network advertising database 112. These data stores may be provided at multiple locations accessible to the servers 92, 98, so as to preserve stored data in the event of a single point of failure and/or to enhance the performance of the system 90. (Similarly, each of the servers 92, 98 may be implemented as a collection of multiple servers, using any of several well-known clustering and/or grid computing techniques. Software configures the servers 92, 98 to implement the functionality of the invention, including responses to user requests, and management of the social network, advertising, database, and related services.

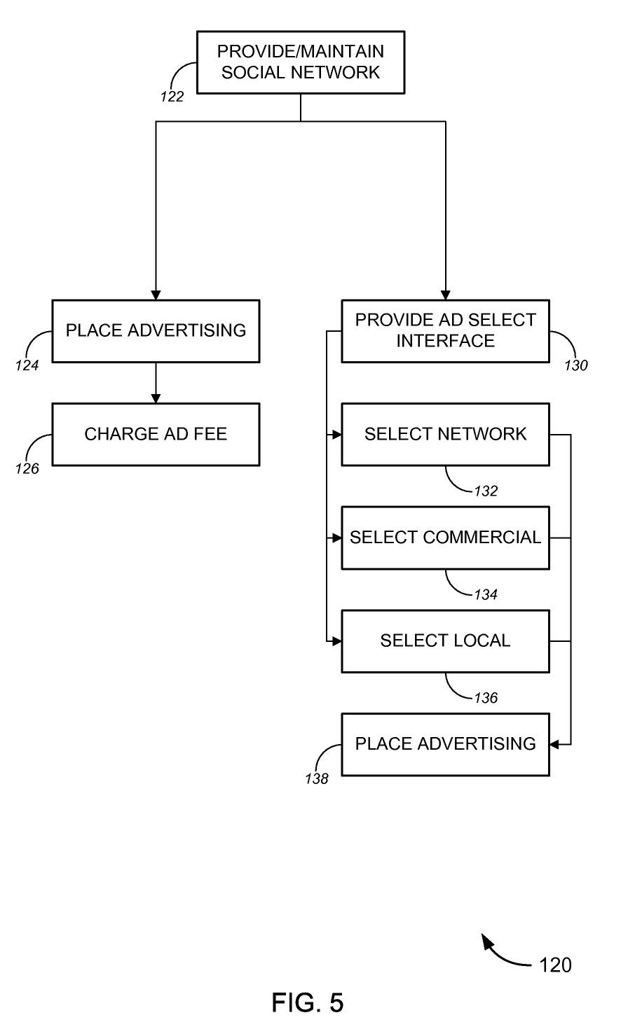

FIG. 5 is a process flow diagram illustrating a method 120 of delivering advertisements to a web page. In a set of embodiments, the method 120 can be implemented within a business social network, as described above. In an aspect, the method 120 can be used to provide advertising on both network web pages (i.e., web pages within a business network, such as individual member pages on a business network web site) and commercial web pages (i.e., web pages on a commercial web site separate from the business network); in many cases, the commercial web pages are associated with a business that is operated by (or employs) one or more members of the business network.

The method 120 comprises providing and/or maintaining a social network (block 120); in particular embodiments, this social network is a social network of businesses (i.e., a business social network). In an aspect, the social network is web-based; that is, the social network comprises one or more web sites (referred to herein as network websites) that allow for interaction between members of the network, provide an architectural framework for the network, and/or the like. In some embodiments, some or all of the members of a business social network may have a network web page on the network web site; as noted above, a particular member's network web page may including biographical information about the member, information about the member's connections with other members, and/or the like.

A few examples of business social networks (and/or the web sites that define such networks) are described above with respect to FIGS. 1-4. In an aspect, as noted above, a business social network has a plurality of members, some or all of which may be associated with businesses. Each business may (but need not necessarily) have a physical location, such as the location of a bricks-and-mortar store operated by the business, a headquarters building, and/or the like.

Providing and maintaining a social network each may comprise one or more procedures, including without limitation providing an interface for new members to join the network, providing communication facilities for members to communicate with one another, establishing and/or maintaining a web site for members of the network to use, providing various services to members of the network, and/or the like. Additional procedures may include, without limitation, maintaining a member database, maintaining the network web pages, and/or the like.

In an exemplary aspect, a social network can be used to generate revenue from advertising, which may be used (at least in part) for the benefit of the members, including by remitting some portions of the revenue to members, by funding services for the members, and/or the like. Hence, in some embodiments, the method 120 includes placing advertising (block 124). In one aspect, placing advertising comprises placing advertisements for one or more entities on web pages associated with members of the network (these web pages can either be network web pages and/or web pages on commercial web sites affiliated with members of the network). As noted above, the determination of where to place advertisements may be the result of one or more evaluations of how appropriate a particular advertisement is for a particular web page (including without limitation evaluation of factors such as whether the member has indicated that a particular type of advertisement should not be placed on that member's web pages, the relevance of a particular advertisement to the subject matter of the web page, the interest/intent of a browsing user, as indicated by the user's browsing history, and/or the like). In an aspect, also as noted above, placing an advertisement may comprise serving that advertisement from a network advertising server in response to a request from a browser visiting the web page on which advertising is placed (e.g., as a result of a link reference from the web page).

In various aspects of the invention, advertisements placed by the provider of the social network (which are sometimes referred to herein informally as advertisements placed by the network) may be either paid advertisements, which are paid for by a sponsor of the advertisement (who generally may be the entity for whom the advertisement provides publicity), or unpaid advertisements, which may be allocated as a reward to members for various activities (for example, as described in further detail below), or some combination of both. Hence, in some cases, the method 120 further comprises charging a fee for the placement of a paid advertisement (block 126). Any of a variety of techniques may be used to account for the placement of paid advertisements and/or charge a fee for such placement. Merely by way of example, a network advertising server may store, e.g., in a database, information about advertisements to be served (including without limitation identification of a sponsor of the advertisement, description of the content and/or subject matter of the advertisement, and/or the like—in many cases, the network provider may also provide an interface for sponsors to upload advertisements and/or provide such corresponding information). When the advertising server serves an advertisement, it may update the database to include data about the service of the advertisement, including such data as date and/or time of service, identification of the web page on which the advertisement was placed, identification of a browser/user to whom the advertisement was served, and/or the like.

Periodically and/or on demand, the system may query the database for information about ads served, and based on this information may compile a consolidated fee for each sponsor based on advertisements served during the period. (Alternatively, fees could be charged on an ad hoc basis, using micropayments, for example, or based on an invoice request received from a sponsor). The vehicle for charging fees and/or receiving payments from sponsors is discretionary; in some cases, an invoicing system may be used, while in other cases, the sponsor may pre-approve one or more payment methods, such as electronic funds withdrawal from a checking account, credit card authorizations, and/or the like. In particular cases, the amount of a fee charged for placement of an advertisement may vary according to the nature of the placement (e.g., the advertising value of the page on which the advertisement is placed and/or of the advertisement itself, as described above); data for determining the amount of the fee charged for a particular placement may also be stored in the network advertising database.

With respect to bonus advertisements allocated to a member as a reward (and also, in some cases, to paid advertisements), the member (and/or sponsor of the advertisement) may be given the option of selecting a location at which the advertisement should be placed. (In this instance, the term “location” generally refers to a web page, or set of web pages, that the advertisement should be placed on, such that when the selected web page(s) is loaded by a browser, the advertisement is served to that browser in conjunction with the selected web page(s).) Hence, the method 120 may comprise providing a selection interface to allow a user (who generally may be member but may also be an advertisement sponsor) to select a preference for one or more types of web pages on which an advertisement should be placed (block 130).

In an embodiment, the selection interface (which may be provided, for example, by a web-based form on a web page on a network web site) allows the user to identify one or more advertisements to be served (e.g., by selecting from a list of advertisements uploaded by the user to the network advertising server, by browsing for a file containing the advertisement on the user's local hard drive, and/or the like) and to identify, based on an of a variety of criteria, what type of web pages (or, in some cases, which specific web pages and/or web sites) on which to serve the advertisement.

Merely by way of example, in some cases, the selection interface may allow the user to select one or more network web pages from among a plurality of network web pages (e.g., member pages) on the network web site (block 132). These pages may be selected based on identities of members associated with the pages, subject matter of the web pages, different affinity criteria (such as the types of businesses with which the members are affiliated, the forums frequented by the members, and/or the like). For instance, the selection interface may provide a list of members from which the user can select one or more members, on whose network pages the advertisements will be placed; similarly, the selection interface may provide a list of forums, a list of different types of subject matter and/or business areas, and/or the like. In some cases, the user may be provided with the ability to search the network for each of these (and other) types of criteria to identify network pages on which advertisements should be placed.

Alternatively and/or additionally, the selection interface may allow the user to select from among commercial web pages and/or web sites (including in particular, but not necessarily limited to, commercial web pages/sites associated with members of the network) for a location on which to place advertisements (block 134). The vehicles for selection of commercial web sites/pages may be similar to that described above with respect to network pages (especially for commercial pages associated with members of the network, since the network may maintain such information about both network pages and commercial pages), along with additional selection criteria, such as domain name, etc.

As noted above, for many businesses (including in particular small businesses), local advertising may be markedly more effective then general Internet-based advertising. Accordingly, in a set of embodiments, the selection interface may be configured to allow the user to specify that advertisements should be placed on web pages associated with members and/or businesses local to the user (i.e., within a specified proximity of the user's—or the user's business's—physical location), and/or to search for such “local” web pages on which to place advertisements (block 136). As noted above, in some embodiments, the system maintains information about the physical location of businesses affiliated with members of the network, and this information can be used to identify web pages associated with businesses local to the user. The user, in some cases, may specify proximity by any acceptable criteria, such as a specified distance from a particular physical location, a ZIP code, a metropolitan area, an area code, and/or the like.

Once the user has selected the placement location(s) for the specified advertisements, the advertisements may be placed by the network advertising server (block 138). This procedure is similar to that described above with respect to block 124, except that, if the advertisement is a bonus advertisement allocated as a reward to a member, the advertisement is placed by the network without charging the member a fee for the placement (or, optionally, charging the member a reduced fee).

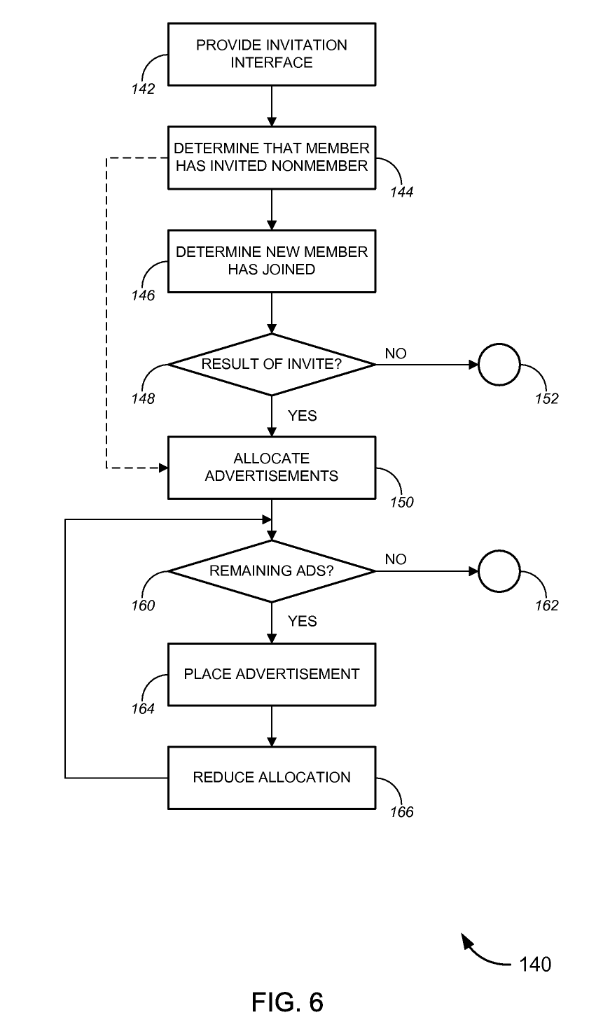

FIG. 6 is a process flow diagram illustrating a method 140 of rewarding members for inviting new members to join a social network, such as the business social networks described above. The method 140 comprises providing an invitation interface to allow members of the network to invite additional businesses (and/or persons associated with such businesses) to join the network as new members. An example of such an interface is described above with respect to portions of FIG. 2. This invitation interface may perform many sub tasks such as educating a member on the benefits of inviting new members and/or on how best to motivate new members to join, providing easy access to a member's contact list (such as a list maintained by a third party application, such as Microsoft Outlook™ and/or other email/contact management applications, providing a simple means of adding new contacts and/or selecting which contact to invite, sending the invitations upon member request, and storing the invitation data in a member database.

The method, in some cases, comprises determining that a member of the business social network has invited a nonmember (e.g., a business—and/or a person affiliated with a business—that is not currently a member of the network) to join the network (block 142). The system can make such a determination, for example, based on receiving the input provided by a member via the invitation interface, by waiting for a specified period of time after an invitation message has been sent without receiving a delivery failure message for the invitation message (indicating that the invitation message was sent to a valid email address), and/or the like.

At block 146, the method comprises determining that a new member has joined the network. This determination can be made based on registration information provided by the new member upon joining the network, for example. In a particular aspect, the method 140 further comprises determining whether the new member has joined the network as a result of an invitation from an existing member (block 148). To determine whether the new member has joined as a result of an invitation from an existing member, the system may correlate registration data (such as a name, email address, and/or the like) about the new member with similar data about invitations extended by members of the network, which, as noted above, may be stored by the system in one or more databases. Alternatively and/or additionally, the new member may be prompted (e.g., during registration) to identify an inviting member (if any), and such identification can be used to determine that the new member has joined the network as the result of an invitation. If the member was not invited to join the network, the method ends (block 152).

Conversely, if it is determined that the new member has joined the network as a result of an invitation from an existing member, that existing member may be rewarded for the successful invitation. Alternatively and/or additionally, as indicated by the broken line on FIG. 6, in some embodiments, the inviting member may be rewarded based merely on the fact that the member invited a non-member to join the network, irrespective of whether the non-member accepts that invitation. In some cases, the inviting member may be rewarded in both situations (i.e., rewarded once for inviting a non-member and rewarded again when the non-member joins the network).

In one set of embodiments, the method provides a reward to the member by allocating, to that member, an allocation of one or more bonus advertisements for the member's business (or for any other legitimate purpose for which the member might want to use the advertisements), based on the determination that the new member joined the network as a result of the invitation from the member and/or a determination that the member has invited a non-member to join the network (block 150). (As noted above, in some cases, a inviting member may receive one allocation of advertisements for inviting a non-member and a second allocation if the non-member does in fact join the network.) In aspect, the allocation does not allocate specific advertisements but instead allocates to the member the specified number of advertisement “slots,” which the member can fill with advertisements of the member's choosing.

A subprocess for allocating and/or placing such advertisements is illustrated by blocks 160-166. At block 160, the system determines whether any advertisements (and/or more specifically, advertisement “slots” ) remain in the allocation of bonus advertisements allocated to the member. If not, the method ends (block 162). If any allocated advertisements remain, the method comprises placing the advertisement (e.g., in accordance with one or more procedures, such as those described above by reference to blocks 130-138 of FIG. 5) (block 164). At this point, the allocation is reduced by the number of advertisements placed (block 166), and the subprocess reiterates (e.g., upon a request by a member to place an additional advertisement). Hence, for example, if a member has an allocation of five bonus advertisement slots, and the member selects one advertisement to be placed, the allocation is reduced to four bonus advertisements.

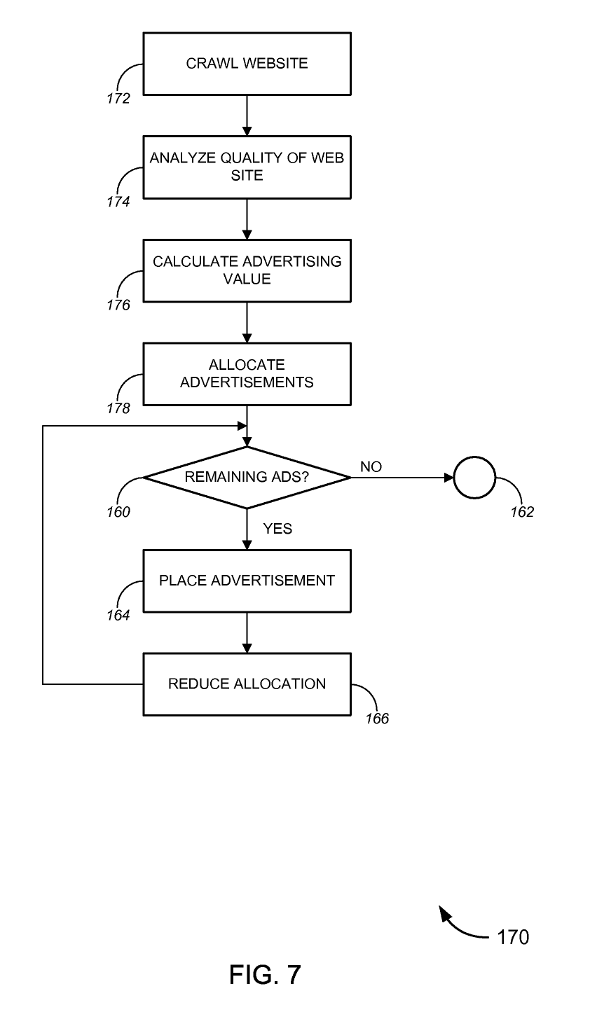

FIG. 7 is a process flow diagram illustrating a method 170 of rewarding network members for enrolling their commercial web site in the network advertising program, or for improving the quality of their enrolled commercial web site. The method, at block 172, comprises crawling (e.g., with a spider component, as described above) a commercial web site associated with a member of the business social network (and/or with a business affiliated with that member) to identify content on the commercial web site (e.g. content on one or more pages on the web site). In one aspect, this crawling procedure may be performed periodically, which can allow the system to identify changes and/or improvements in any such content. Identifying the content of the web site may include downloading and/or analyzing some or all of the web pages on the web site.

At block 174, the method comprises analyzing a quality of content on the commercial web site. In various embodiments, this analysis can include evaluation of a number of factors, including without limitation those factors described above. Merely by way of example, the analysis might include an analysis of the size and/or location of network advertising on each of the web pages on the site, the amount and/or location of original content on each web page, linked content on each web page, graphical and/or multimedia content on each web page, and/or the like. In some cases, an analysis of the quality of the content on the web site might also consider traffic statistics for the web site (and/or pages thereon), as well as subjective rankings given the web site/pages by visitors, as described above.

Based on this analysis, the advertising value of the site is calculated (block 176). In some cases, this calculation is performed by an advertising value calculation engine, by applying an advertising value algorithm, as described above. The method 170, then, further comprises, allocating, to the member with which the commercial web site is associated, an allocation of one more advertisements. This procedure, in some embodiments, may be similar to the procedure described above with respect to block 148 on FIG. 6. Further, the method may also include the subprocess (illustrated by blocks 160-166) for allocating and/or placing advertisements, as described above with respect to FIG. 6.

It should be noted that many variations of the procedures described with respect to these methods are possible within the scope of the invention. Merely by way of example, while FIG. 7 describes procedures for analyzing commercial web sites, these procedures could be equally applicable to the analysis of a member's network web page(s). Similarly, while the procedures for selecting a location for advertisements in FIG. 5 are described primarily with respect to bonus member advertisements, those same procedures could be used to selection locations for paid advertisements as well.

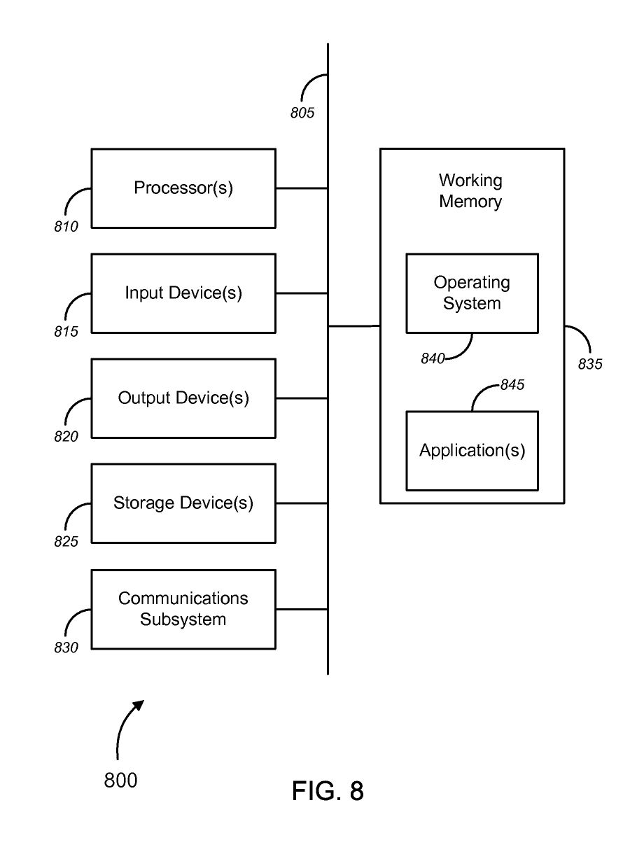

FIG. 8 provides a schematic illustration of one embodiment of a computer system 800 that can perform the methods of the invention, as described herein, and/or can function as any of the servers and/or user computers described herein. It should be noted that FIG. 8 is meant only to provide a generalized illustration of various components, any or all of which may be utilized as appropriate. FIG. 8, therefore, broadly illustrates how individual system elements may be implemented in a relatively separated or relatively more integrated manner.

The computer system 800 is shown comprising hardware elements that can be electrically coupled via a bus 805 (or may otherwise be in communication, as appropriate). The hardware elements can include one or more processors 810, including without limitation one or more general-purpose processors and/or one or more special-purpose processors (such as digital signal processing chips, graphics acceleration chips, and/or the like); one or more input devices 815, which can include without limitation a mouse, a keyboard and/or the like; and one or more output devices 820, which can include without limitation a display device, a printer and/or the like.

The computer system 800 may further include (and/or be in communication with) one or more storage devices 825, which can comprise, without limitation, local and/or network accessible storage and/or can include, without limitation, a disk drive, a drive array, an optical storage device, solid-state storage device such as a random access memory (“RAM”) and/or a read-only memory (“ROM”), which can be programmable, flash-updateable and/or the like. The computer system 800 might also include a communications subsystem 830, which can include without limitation a modem, a network card (wireless or wired), an infra-red communication device, a wireless communication device and/or chipset (such as a Bluetooth™ device, an 802.11 device, a WiFi device, a WiMax device, cellular communication facilities, etc.), and/or the like. The communications subsystem 830 may permit data to be exchanged with a network (such as the network described below, to name one example), and/or any other devices described herein. In many embodiments, the computer system 800 will further comprise a working memory 835, which can include a RAM or ROM device, as described above.

The computer system 800 also can comprise software elements, shown as being currently located within the working memory 835, including an operating system 840 and/or other code, such as one or more application programs 845, which may comprise computer programs of the invention, and/or may be designed to implement methods of the invention and/or configure systems of the invention, as described herein. Merely by way of example, one or more procedures described with respect to the method(s) discussed above might be implemented as code and/or instructions executable by a computer (and/or a processor within a computer). A set of these instructions and/or code might be stored on a computer readable storage medium, such as the storage device(s) 825 described above. In some cases, the storage medium might be incorporated within a computer system, such as the system 800. In other embodiments, the storage medium might be separate from a computer system (i.e., a removable medium, such as a compact disc, etc.), and or provided in an installation package, such that the storage medium can be used to program a general purpose computer with the instructions/code stored thereon. These instructions might take the form of executable code, which is executable by the computer system 800 and/or might take the form of source and/or installable code, which, upon compilation and/or installation on the computer system 800 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

In one aspect, the invention employs a computer system (such as the computer system 800) to perform methods of the invention. According to a set of embodiments, some or all of the procedures of such methods are performed by the computer system 800 in response to processor 810 executing one or more sequences of one or more instructions (which might be incorporated into the operating system 840 and/or other code, such as an application program 845) contained in the working memory 835. Such instructions may be read into the working memory 835 from another machine-readable medium, such as one or more of the storage device(s) 825. Merely by way of example, execution of the sequences of instructions contained in the working memory 835 might cause the processor(s) 810 to perform one or more procedures of the methods described herein.

The terms “machine readable medium” and “computer readable medium,” as used herein, refer to any medium that participates in providing data that causes a machine to operation in a specific fashion. In an embodiment implemented using the computer system 800, various machine-readable media might be involved in providing instructions/code to processor(s) 810 for execution and/or might be used to store and/or carry such instructions/code (e.g., as signals). In many implementations, a computer readable medium is a physical and/or tangible storage medium. Such a medium may take many forms, including but not limited to, non-volatile media, volatile media, and transmission media. Non-volatile media includes, for example, optical or magnetic disks, such as the storage device(s) 825. Volatile media includes, without limitation dynamic memory, such as the working memory 835. Transmission media includes coaxial cables, copper wire and fiber optics, including the wires that comprise the bus 805, as well as the various components of the communication subsystem 830 (and/or the media by which the communications subsystem 830 provides communication with other devices). Hence, transmission media can also take the form of waves (including without limitation radio, acoustic and/or light waves, such as those generated during radio-wave and infra-red data communications).

Common forms of physical and/or tangible computer readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of machine readable media may be involved in carrying one or more sequences of one or more instructions to the processor(s) 810 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 800. These signals, which might be in the form of electromagnetic signals, acoustic signals, optical signals and/or the like, are all examples of carrier waves on which instructions can be encoded, in accordance with various embodiments of the invention.

The communications subsystem 830 (and/or components thereof) generally will receive the signals, and the bus 805 then might carry the signals (and/or the data, instructions, etc. carried by the signals) to the working memory 835, from which the processor(s) 805 retrieves and executes the instructions. The instructions received by the working memory 835 may optionally be stored on a storage device 825 either before or after execution by the processor(s) 810.

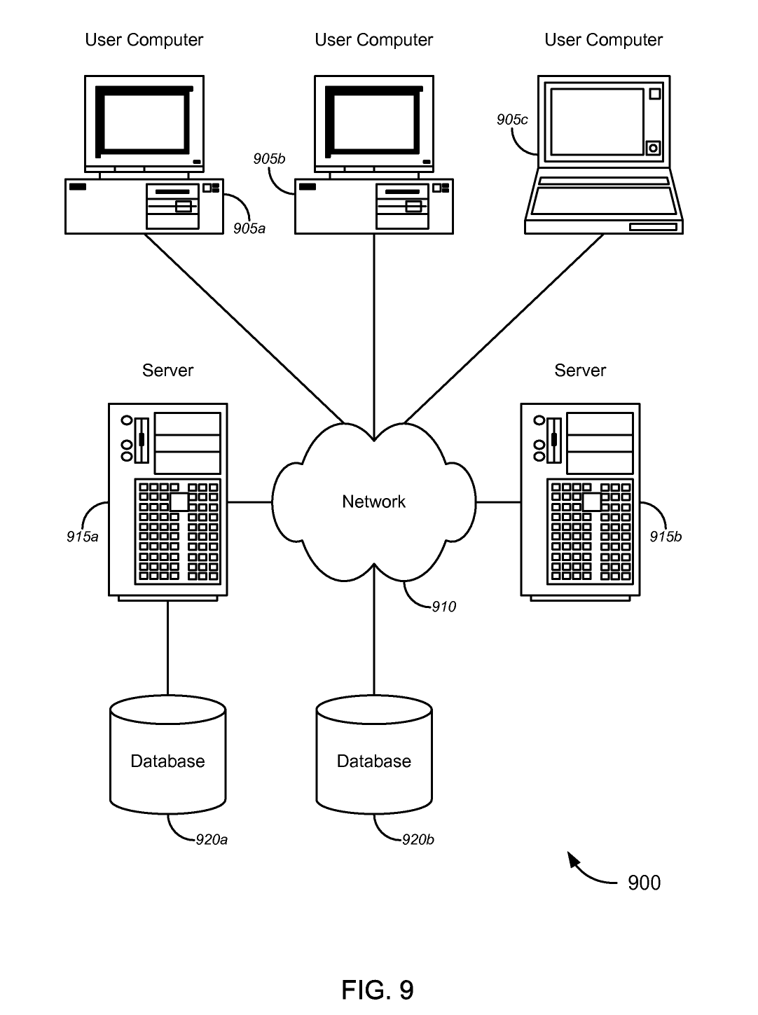

A set of embodiments comprises systems that provide and/or maintain social networks, and/or that provide services in conjunction with such networks. FIG. 9 illustrates a schematic diagram of a networked computer system 900 that can be used in accordance with one set of embodiments to provide such services. The system 900 can include one or more user computers 905. The user computers 905 can be general purpose personal computers (including, merely by way of example, personal computers and/or laptop computers running any appropriate flavor of Microsoft Corp.'s Window™ and/or Apple Corp.'s Macintosh™ operating systems) and/or workstation computers running any of a variety of commercially-available UNIX™ or UNIX-like operating systems. These user computers 905 can also have any of a variety of applications, including one or more applications configured to perform methods of the invention, as well as one or more office applications, database client and/or server applications, and web browser applications. Alternatively, the user computers 905 can be any other electronic device, such as a thin-client computer, Internet-enabled mobile telephone, and/or personal digital assistant, capable of communicating via a network (e.g., the network 910 described below) and/or displaying and navigating web pages or other types of electronic documents. Although the exemplary system 900 is shown with three user computers 905, any number of user computers can be supported.

Certain embodiments of the invention operate in a networked environment, which can include a network 910. The network 910 can be any type of network familiar to those skilled in the art that can support data communications using any of a variety of commercially-available protocols, including without limitation TCP/IP, SNA, IPX, AppleTalk, and the like. Merely by way of example, the network 910 can be a local area network (“LAN”), including without limitation an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol known in the art, and/or any other wireless protocol; and/or any combination of these and/or other networks.

Embodiments of the invention can include one or more server computers 915. Each of the server computers 915 may be configured with an operating system, including without limitation any of those discussed above, as well as any commercially (or freely) available server operating systems. Each of the servers 915 may also be running one or more applications, which can be configured to provide services to one or more clients 905 and/or other servers 915.

Merely by way of example, one of the servers 915 may be a web server, which can be used, merely by way of example, to process requests for web pages or other electronic documents from user computers 905 and/or to provide various services to members of a business social network, as described above. The web server can also run a variety of server applications, including HTTP servers, FTP servers, CGI servers, database servers, Java servers, and the like. In some embodiments of the invention, the web server may be configured to serve web pages that can be operated within a web browser on one or more of the user computers 905 to perform methods of the invention.

The server computers 915, in some embodiments, might include one or more application servers, which can include one or more applications accessible by a client running on one or more of the client computers 905 and/or other servers 915. Merely by way of example, the server(s) 915 can be one or more general purpose computers capable of executing programs or scripts in response to the user computers 905 and/or other servers 915, including without limitation web applications (which might, in some cases, be configured to perform methods of the invention). Merely by way of example, a web application can be implemented as one or more scripts or programs written in any suitable programming language, such as Java™, C, C#™ or C++, and/or any scripting language, such as Perl, Python, or TCL, as well as combinations of any programming/scripting languages. The application server(s) can also include database servers, including without limitation those commercially available from Oracle, Microsoft, Sybase™, IBM™ and the like, which can process requests from clients (including, depending on the configuration, database clients, API clients, web browsers, etc.) running on a user computer 905 and/or another server 915.

In some embodiments, an application server can create web pages dynamically for displaying the information in accordance with embodiments of the invention, such as any of the web pages described above (e.g., web pages for displaying elements of a business social network web site, member pages, etc.). Data provided by an application server may be formatted as web pages (comprising HTML, Javascript, etc., for example) and/or may be forwarded to a user computer 905 via a web server (as described above, for example). Similarly, a web server might receive web page requests and/or input data from a user computer 905 and/or forward the web page requests and/or input data to an application server. In some cases a web server may be integrated with an application server.

In accordance with further embodiments, one or more servers 915 can function as a file server and/or can include one or more of the files (e.g., application code, data files, etc.) necessary to implement methods of the invention incorporated by an application running on a user computer 905 and/or another server 915. Alternatively, as those skilled in the art will appreciate, a file server can include all necessary files, allowing such an application to be invoked remotely by a user computer 905 and/or server 915. It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 920. The location of the database(s) 920 is discretionary: merely by way of example, a database 920a might reside on a storage medium local to (and/or resident in) a server 915a(and/or a user computer 905). Alternatively, a database 920b can be remote from any or all of the computers 905, 915, so long as it can be in communication (e.g., via the network 910) with one or more of these. In a particular set of embodiments, a database 920 can reside in a storage-area network (“SAN”) familiar to those skilled in the art. (Likewise, any necessary files for performing the functions attributed to the computers 905, 915 can be stored locally on the respective computer and/or remotely, as appropriate.) In one set of embodiments, the database 935 can be a relational database, such as an Oracle database, that is adapted to store, update, and retrieve data in response to SQL-formatted commands. The database might be controlled and/or maintained by a database server, as described above, for example.

While the invention has been described with respect to exemplary embodiments, one skilled in the art will recognize that numerous modifications are possible. For example, the methods and processes described herein may be implemented using hardware components, software components, and/or any combination thereof Further, while various methods and processes described herein may be described with respect to particular structural and/or functional components for ease of description, methods of the invention are not limited to any particular structural and/or functional architecture but instead can be implemented on any suitable hardware, firmware and/or software configuration. Similarly, while various functionality is ascribed to certain system components, unless the context dictates otherwise, this functionality can be distributed among various other system components in accordance with different embodiments of the invention.

Moreover, while the procedures comprised in the methods and processes described herein are described in a particular order for ease of description, unless the context dictates otherwise, various procedures may be reordered, added, and/or omitted in accordance with various embodiments of the invention. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary features, the various components and/or features described herein with respect to a particular embodiment can be substituted, added and/or subtracted from among other described embodiments, unless the context dictates otherwise. Consequently, although the invention has been described with respect to exemplary embodiments, it will be appreciated that the invention is intended to cover all modifications and equivalents within the scope of the following claims.

What is claimed is:

1. A method of enhancing participation in a web-based business network, the method comprising:
maintaining a web-based social network of businesses, the social network comprising a plurality of relationships among a plurality of members, the plurality of members comprising a first member that is associated with a first business having a first physical location, the web-based social network further comprising a network web site, the network web site comprising a network web page associated with the first member, the first member further having associated therewith a commercial web site separate from the network web site;
placing paid advertisements on one or more web pages;
charging a fee for the placement of each paid advertisement;
providing an interface to allow each member to invite additional businesses to join the web-based social network;
allocating, to the first member, a first allocation of one or more advertisements for the first business, based on a determination that the first member has invited an additional business to joint the web-based social network;
periodically crawling, with a spider component, the commercial web site to identify content on the commercial web site;
analyzing a quality of content of the commercial web site;
based on an analysis of the quality of the content of the commercial web site, calculating an advertising value of the commercial web site; and
allocating, to the first member, a second allocation of one or more advertisements for the first business, based on the calculated advertising value of the commercial web site;
wherein allocating, to the first member, the first and second allocations of one more advertisements for the first business comprises placing the one or more allocated advertisements on one or more web pages without charging the first member a fee for placement of the one or more advertisements.

2. The method of claim 1, further comprising:
providing, to the first member, a badge that can be placed on the commercial web site, wherein the badge identifies the first business as a member of the social network, and wherein the badge provides a link to the network web page associated with the first member.

3. A method of enhancing participation in a web-based business network, the method comprising:
maintaining a web-based social network of businesses, the social network comprising a plurality of relationships among a plurality of members, the plurality of members comprising a first member that is associated with a first business having a first physical location, the web-based social network further comprising a network web site, the network web site comprising a network web page associated with the first member;
providing an interface to allow one or more members to invite additional businesses to join the web-based social network;
determining that the first member has invited a non-member to join the web-based social network; and
allocating, to the first member, an allocation of one or more advertisements for the first business, based on a determination that the first member has invited a non-member to join the web-based social network.

4. The method of claim 3, further comprising:
determining that a new member has joined the web-based social network as a result of an invitation from the first member; and
allocating, to the first member, a second allocation of one or more advertisements, based on a determination that the new member has joined the web-based social network as a result of an invitation from the first member.

5. The method of claim 3, further comprising:
placing, on one or more web pages, paid advertisements for businesses associated with members of the social network; and
charging a fee for the placement of each paid advertisement;
wherein allocating, to the first member, an allocation of one or more advertisements comprises:
placing the one or more allocated advertisements on one or more web pages; and
charging the member no fee or a reduced fee for the placement of each of the one or more allocated advertisements.

6. The method of claim 3, wherein placing, on one or more web pages, advertisements for businesses associated with members of the social network comprises placing the advertisements on one or more of the network web pages.

7. The method of claim 3, wherein placing, on one or more web pages, advertisements for businesses associated with members of the social network comprises placing the advertisements on one or more web pages separate from the network web site.

8. The method of claim 7, wherein the one or more web pages separate from the network web site comprises one or more commercial web pages associated with one or more members of the social network.

9. The method of claim 3, further comprising:
providing a selection interface to allow the first member to select one or more web pages on which each of the one or more advertisements allocated to the first member should be placed.

10. The method of claim 9, wherein the selection interface allows the first member to select from among a plurality of network web pages on the network web site.

11. The method of claim 9, wherein at least some of the plurality of members have associated therewith commercial web pages maintained on web sites separate from the network web site, and wherein the selection interface allows the first member to select from among the commercial web pages.

12. The method of claim 9, wherein the selection interface is configured to allow the first member to select one or more web pages associated with members having physical locations within a specified proximity of the first physical location.

13. The method of claim 12, wherein the specified proximity is selected from the group consisting of: a specified distance from the first physical location, a ZIP code of the first physical location, a metropolitan area of the first physical location, and an area code of the first physical location.

14. The method of claim 3, wherein allocating, to the first member, an allocation of one or more advertisements comprises:
placing an allocated advertisement on a network web page to be viewed by the new member; and
charging the first member no fee or a reduced fee for the placement of the allocated advertisement.

15. A method of enhancing participation in a web-based business network, the method comprising:
maintaining a web-based social network of businesses, the social network comprising a plurality of relationships among a plurality of members, the plurality of members comprising a first member that is associated with a first business having a first physical location, the web-based social network further comprising a network web site, the network web site comprising a network web page associated with the first member, the first member further having associated therewith a commercial web site separate from the network web site;
periodically crawling, with a spider component, the commercial web site to identify content on the commercial web site;
analyzing a quality of content of the commercial web site;
based on an analysis of the quality of the content of the commercial web site, calculating an advertising value of the commercial web site; and
allocating, to the first member, an allocation one or more advertisements for the first business, based at least in part on the calculated advertising value of the commercial web site.

16. The method of claim 15, wherein analyzing a quality of content on the web site comprises identifying a number of advertisements served by the web-based social network and/or a location, on the commercial web site, of one or more advertisements related to the web-based social network.

17. The method of claim 15, wherein analyzing a quality of content on the web site comprises identifying relative portions of linked content and original content on the commercial web site.

18. The method of claim 15, wherein analyzing a quality of content on the web site comprises identifying the presence of one or more images and/or video files on the commercial web site.

19. The method of claim 15, wherein analyzing a quality of content on the web site comprises analyzing an improvement of the quality of content on the web site over a period of time.

20. The method of claim 15, wherein analyzing a quality of content on the web site comprises ranking the subject matter according to advertiser interest.

21. A method, comprising:
maintaining a web-based social network of businesses, the social network comprising a plurality of relationships among a plurality of members;
placing, on one or more web pages, paid advertisements for businesses associated with members of the social network; and
charging a fee for the placement of each paid advertisement.

22. The method of claim 21, further comprising:
establishing a set of one or more conditions under which a member of the social network qualifies for placement of one or more advertisements without payment of a fee;
determining that a first member of the social network has fulfilled one or more of the conditions; and
allocating, to the first member, an allocation of one or more member advertisements for the first business, based on a determination that the first member has fulfilled the one or more of the conditions.

23. A computer system for enhancing participation in a web-based business network, the system comprising:
a processor; and
a computer readable medium in communication with the processor, the computer readable medium having encoded thereon a set of instructions executable by the computer system to perform one or more operations, the set of instructions comprising:
instructions for maintaining a web-based social network of businesses, the social network comprising a plurality of relationships among a plurality of members, the plurality of members comprising a first member that is associated with a first business having a first physical location, the web-based social network further comprising a network web site, the network web site comprising a network web page associated with the first member;
instructions for providing an interface to allow each member to invite additional businesses to join the web-based social network;
instructions for determining that the first member has invited a non-member to join the web-based social network; and
instructions for allocating, to the first member, an allocation of one or more advertisements for the first business, based on a determination that the first member has invited a non-member to join the web-based social network.

24. An apparatus, comprising:
a computer readable medium having encoded thereon a set of instructions executable by a computer system to perform one or more operations, the set of instructions comprising:
instructions for maintaining a web-based social network of businesses, the social network comprising a plurality of relationships among a plurality of members, the plurality of members comprising a first member that is associated with a first business having a first physical location, the web-based social network further comprising a network web site, the network web site comprising a network web page associated with the first member, the first member further having associated therewith a commercial web site separate from the network web site;
instructions for periodically crawling, with a spider component, the commercial web site to identify content on the commercial web site;
instructions for analyzing a quality of content of the commercial web site;
instructions for calculating an advertising value of the commercial web site, based on an analysis of the quality of the content of the commercial web site; and
instructions for allocating, to the first member, an allocation one or more advertisements for the first business, based at least in part on the calculated advertising value of the commercial web site.

25. A system, the system comprising:
one or more computers, each computer comprising a processor; and
a computer readable medium in communication with the one or more computers, the computer readable medium comprising instructions executable by at least one of the one or more computers to provide an advertising network web site for members of an affinity network, the advertising network web site comprising at least an advertising network web page for providing members an advertising service to serve network advertising on web pages on a web site associated with a member of the affinity network, the advertising service comprising:
a spidering service configured to determine member web page content data, the member web page content data comprising information about one or more locations of network advertisements within each member web page;
an advertising value calculation engine for calculating an advertising value of a member web page based on one or more factors selected from the group consisting of:
a number of network advertisements on the member web page,
one or more locations of network advertisements on the member web page; and
a quality of content on the member web page; and
a network advertising server that serves advertisements to member web pages based on relevance of each advertisement to member web page content data, the network advertisements comprising paid advertisements sourced from commercial advertisers, and member advertisements sourced from one or more members of the affinity network to promote businesses associated with the one or more members of the affinity network;
wherein an earned number of member advertisements that are served by the network advertising server on behalf of a member depends on the advertising value of the member web pages as calculated by the advertising value calculation engine.

26. The system of claim 25, further wherein the advertising network web site further comprises:
a promotional network web page providing members with a promotional service for expanding membership in the affinity network, the promotional service comprising a message sender for sending electronic message invitations to join the affinity network to any of the contacts of the member when selected by the member;
wherein the affinity network advertising service maintains a record of a number of electronic message invitations sent by a member and allocates to the member an allocation of bonus advertisements based on the number of invitations.

27. The system of claim 26, wherein the allocation comprises a first quantity of bonus advertisements.

28. The system of claim 27, wherein the bonus advertisements are served to new members who registered with the network as a result of the invitation.

29. The system of claim 26, wherein the electronic message invitations are sent by email.

30. The system of claim 25, wherein the advertising web site further comprises a network cookie server configured to:
store, on a data storage device on a first user computer, a cookie that comprises a unique label for the first user computer; and
in response to a page request from the first user computer for a member web page, obtain the unique label from the cookie stored on the data storage device on the first user computer;
obtain, from advertising database, data about a history of browsing activity of the first user computer, based on the unique label; and
provide, to the advertising server, the data about the history of browsing activity;
wherein the advertising server is configured to select an advertisement to be served to the first user computer, based at least in part on the data about a history of browsing activity of the first user computer .

31. The advertising network website of claim 25, further comprising a member forum network web page providing members with a member forum service for discussing topics of interest with other network members, the member forum service comprising at least an electronic bulletin board where members may post comments and questions on topics of their own choosing and in response to other members' postings.
